(19) United States
(12) Patent Application Publication
(10) Pub. No.: US 2014/0267380 A1
(43) Pub. Date: Sep. 18, 2014

(54) SYSTEM AND METHOD FOR EFFICIENTLY VIEWING A STYLE

(71) Applicant: COREL CORPORATION, Ottawa (CA)

(72) Inventors: Adam John Michael Letts, Ottawa (CA); Hendrik Jouwert Wagenaar, Ottawa (CA)

(73) Assignee: Corel Corporation, Ottawa (CA)

(21) Appl. No.: 13/801,051

(22) Filed: Mar. 13, 2013

(51) Int. Cl. G06T 11/60

(52) U.S. Cl. CPC G06T 11/60
USPC 345/619

(57) ABSTRACT

A method includes the steps of: providing a computer readable non-transitory storage medium including a computer readable code configured to run on a computer and to perform a process to view an assignment of a style to an object of a computer drawing; selecting the style for view; choosing by computer a sample object, the sample object configured to visually demonstrate one or more visual properties of the style; applying by computer the style to the sample object; rendering by computer the sample object to a bit mapped image suitable for display on a computer display; and displaying by computer the pixelated image on the computer display. A system to perform the method is also described. A method to assign a child style to an object, where the child style includes one or more properties inherited from a parent style is also described.

### FIELD OF THE INVENTION

The invention relates to a system and method to view a style and more particularly to a process to efficiently view a style of an object of a computer drawing.

### BACKGROUND OF THE INVENTION

Drawings can be created on a computer by adding objects to the drawing. The objects can be placed at any location within an available drawing space. Characters of text and shapes are both examples of objects that can be added to a drawing.

One or more properties can be assigned to each object. Certain properties are often associated with a given type of object. For example, characters of text can have properties such as attributes of font size and font type. Objects such as rectangles can be assigned properties such as a fill color and a line thickness attribute. It is common for more than one property to be an assigned to an object. A group of properties assigned to an object can be defined by a style. Thus, by assigning a style to any given object, a group of properties is efficiently assigned to the object.

Once a style is assigned to one or more objects in a computer drawing, the objects show the visible properties of the style. However, once styles are so assigned, the underlying drawing file has also been changed. Also, it can be inefficient to redraw and/or re-render a full representation of the computer drawing to the computer display just to test the effect of a style assignment.

### SUMMARY OF THE INVENTION

There is a need for an improved method to more easily view a style before applying it to an object in a computer drawing.

According to one aspect, the invention features a method which includes the steps of: providing a computer readable non-transitory storage medium including a computer readable code configured to run on a computer and to perform a process to view an assignment of a style to an object of a computer drawing; selecting the style for view; choosing by computer a sample object, the sample object configured to visually demonstrate one or more visual properties of the style; applying by computer the style to the sample object; rendering by computer the sample object to a bit mapped image suitable for display on a computer display; and displaying by computer the pixelated image on the computer display.

In one embodiment, the step of selecting the style to view includes selecting a style from the group consisting of a style to preview, a style to create, and a style to edit.

In another embodiment, the step of choosing by computer a sample object includes choosing a sample object selected from a group of generic objects.

In yet another embodiment, the step of rendering by computer the sample object to a bit mapped image suitable for display on a computer display includes displaying the bit mapped image in a window.

In yet another embodiment, the step of rendering by computer the sample object to a bit mapped image suitable for display on a computer display includes displaying the bit mapped image in a tool tip window.

In yet another embodiment, an underlying computer file of the computer drawing remains unmodified by the process to view an assignment of the style to an object of a computer drawing.

In yet another embodiment, the style is a parent style or a child style.

In yet another embodiment, the object includes a shape.

In yet another embodiment, the object includes one or more characters of text.

In yet another embodiment, the object includes one or more paragraphs of text.

In yet another embodiment, the object includes a barcode object and the process to view an assignment of a style to an object of a computer drawing operates without information of any data stored within the barcode.

In yet another embodiment, the barcode is a QR code.

According to another aspect, the invention features a system which includes a computer configured to run a computer readable non-transitory storage medium including a computer readable code configured to run on the computer and to perform a process to view an assignment of a style to an object of a computer drawing. A user input device is communicatively coupled to the computer. The computer readable code is configured to recognize a selection of the style for view made with the user input device and to choose a sample object. The sample object is configured to visually demonstrate one or more visual properties of the style, and to apply by computer the style to the sample object, and to render by computer the sample object to a bit mapped image suitable for display on a computer display, and to display by computer the pixelated image on the computer display.

According to yet another aspect, the method includes the steps of: providing a computer readable non-transitory storage medium including a computer readable code configured to run on a computer and to perform a process to assign a child style to an object, the child style including one or more properties inherited from a parent style; selecting a parent style; creating a child style to inherit the one or more properties from the parent style; assigning the created child style to an object; and applying by computer the created child style to the object of the computer drawing.

In one embodiment, the method further includes the step of providing a process to view an assignment of a style to an object of a computer drawing as described hereinabove, and between the step of creating a child style and the step of assigning the created child style to an object, the step of viewing the child style.

According to yet another aspect, the method including the steps of: providing a computer readable non-transitory storage medium including a computer readable code configured to run on a computer and to perform a process to view an assignment of a style set to an object of a computer drawing; selecting the style set for view; choosing by computer a sample object, the sample object configured to visually demonstrate one or more visual properties of the style set; applying by computer the style set to the sample object; rendering by computer the sample object to a bit mapped image suitable for display on a computer display; and displaying by computer the pixelated image on the computer display.

In one embodiment, the step of selecting the style set to view includes selecting a style set from the group consisting of a style set to preview, a style set to create, and a style set to edit.

In one embodiment, the style set is a parent style set or a child style set.

In another embodiment, the step of choosing by computer a sample object includes choosing a sample object selected from a group of generic objects.

In yet another embodiment, the step of rendering by computer the sample object to a bit mapped image suitable for display on a computer display includes displaying the bit mapped image in a window.

In yet another embodiment, the step of rendering by computer the sample object to a bit mapped image suitable for display on a computer display includes displaying the bit mapped image in a tool tip window.

In yet another embodiment, an underlying computer file of the computer drawing remains unmodified by the process to view an assignment of the style set to an object of a computer drawing.

In yet another embodiment, the style set is a parent style set or a child style set.

In yet another embodiment, the object includes a shape.

In yet another embodiment, the object includes one or more characters of text.

In yet another embodiment, the object includes one or more paragraphs of text.

In yet another embodiment, the object includes a barcode object and the process to view an assignment of a style set to an object of a computer drawing operates without information of any data stored within the barcode.

In yet another embodiment, the barcode includes a QR code.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows a drawing which illustrates an exemplary structure of a style;

FIG. 2 shows a drawing which illustrates another aspect of styles referred to as inheritance;

FIG. 3 shows a block diagram illustrating an exemplary style process advancing with time;

FIG. 4A shows an exemplary docker with a tooltip view;

FIG. 4B shows an exemplary context of a style being applied to an object;

FIG. 4C shows an exemplary resulting object after the style of FIG. 4B has been applied to the object;

FIG. 5 shows a block diagram of an exemplary method for efficiently viewing a style; and

FIG. 6 shows block diagram of an exemplary method to assign a child style inherited from a parent style to an object of a computer drawing.

### DETAILED DESCRIPTION

An object is an item that can be placed in a drawing space. Exemplary objects include shapes, lines, fonts, barcodes (1D or 2D), etc. Groups of one or more properties can be assigned to an object in a computer drawing by assigning a “style” to the object. Similarly, groups of one or more styles can be assigned to an object as a “style set” (a set of styles). Typically, a user is placing a new object in a drawing or has selected one or more objects for editing when assigning a style to the one or more objects. The problem is that there can be many styles to choose from when assigning a style. Therefore, typically a user assigns some number of styles as trial or test cases before settling on a particular style choice. In the prior art, this generally means actually applying the style, if only for a moment, then returning to the computer drawing just before the style was assigned. Such style testing is inefficient and needlessly causes full screen redrawing and/or re-rendering of the drawing for a particular view and screen configuration (screen resolution, etc.) as well as needless changes to the underlying computer drawing file. Such changes to the drawing file also cause unnecessary RAM and/or hard drive write cycles. Initially, a style change typically modifies the document representation in RAM as used by the application while it is running. However, change to a document file in the file system (typically a file on a hard drive) can later occur due to auto-save or an explicit save operation.

Many computer programs include an Undo/Redo function. A further reason to avoid applying changes for experimental reasons is that application of a change adds an entry to the Undo stack (used by Undo/Redo operations). If the user applies experimental changes successively, then this list becomes populated by these spurious operations (at the expense of memory, or if Undo history is limited, then at the expense of older entries in the Undo history). If the user is instead conscientious and undoes each operation, then each Undo operation also incurs processing time. Where it is possible to view the Undo history, these entries are generally undesirable. If the user wants to restore the document to a state in which it existed before application of the experimental changes via undo operations, it is typically necessary to undo all of the changes (whether done after each experiment, or as a batch after all experimenting).

One solution to the problem of viewing the application of styles to an object in a drawing or document is a process that displays a sample object having the properties of a style under consideration, before actually applying the style to an object in a computer drawing or document. The process of viewing the application of a style includes previewing the application of a style to an object, viewing a style that might be created, and/or viewing a style that is available for editing which is already being applied to an object. The same process can be used to display a sample object having the properties of a style set under view or consideration, before actually applying the style set to an object in a computer drawing or document. Viewing the application of a style set also includes previewing the application of a style set to an object, viewing a style set that might be created, and viewing a style set that is available for editing which is already be applied to an object. The processes for generating a view of an object described herein include preview processes, creation processes, and editing processes for both styles and style sets.

Now describing a create in more detail, there can be sub-options underneath “create” which allow for the creation of a specific type of style appropriate to the object. For example, a rectangle can have sub-options for creating an “outline” style or “fill” style. Similarly, there can be sub-options under “edit” for each type of style that is currently applied to the object (e.g. a particular object might happen to have an “outline” style applied, but no “fill” style, so only its “outline” style would appear).

Create views can be a means for visualizing a style that can (or is about to) be created, such as for example, from an existing object. A preview view is substantially the same as what can be seen if you first create the style and then view a preview of that style. A view of style (or style set) creation can display a preview of a sample object with an instance of a certain type of style applied, where that style is a result of extracting those properties of the object that are applicable to that type of style. For a create view, a temporary style can be generated just for the duration of preview generation. If the style is not created, but only viewed and rejected, it can be discarded without saving.

Views shown in the “edit” case can be representative of the current state of an object. The edit view can invoke a view using a style which is currently applied to the object. For example, selecting a style name under “edit” can invoke a style docker where changes can be made to that style. Views by preview, create, and/or edit can provide a means of helping to visualize the contribution that a certain style is making to an object's appearance, and provide an additional means of helping a user to select the appropriate style for editing (and/or application to another object) in the case that there is more than one type of style applied to an object.

According to one embodiment of the process, the process begins with providing a computer readable non-transitory storage medium comprising computer readable code configured to run on a computer and to perform a process to view an assignment of a style to an object of a computer drawing. A stylized sample object can be displayed on the computer display screen. It is unimportant to the process whether the stylized sample object is displayed over a portion of a drawing screen, a displayed computer drawing, or within a window, such as a “pop-up” window. In some computer programs, such a window is referred to as a tool tip window. A tooltip window is typically a separate window from the window showing the drawing. In some embodiments, the tooltip window can appear after the cursor hovers over a style name (or apply, edit, or create option) for a certain period of time.

It is also unimportant to the process whether the sample object is of the exact same type of object as an object being edited in the drawing. The sample object (e.g. a “generic” object) can be chosen as an object capable of displaying the visual attributes of the style being viewed. That is, the sample object is configured to visually demonstrate one or more visual properties of the style to be viewed. Following a user selection of a style for view, the computer program selects such a suitable sample object, applies the selected style for view to the sample object, rasterizes the sample object (e.g. conversion from a sample vector object to a bit map representation of the object), and displays the stylized sample object in a window (e.g. a tool tip window). There are several advantages to using a sample object to view styles. There is no change to the underlying drawing file during the style view process. Thus a user rapidly cycling through a number of style views need not be concerned about the drawing being accidentally changed. Also, since the sample object is rendered to a relatively small graphic space on the computer display, the screen rendering time of the stylized sample object is a small fraction of the time it would take to otherwise redraw the displayed drawing. As described hereinabove, it is the display of the modified object in document context that is often most expensive. Objects occupying the object's extents are typically re-rendered along with the modified object, and any further effects applied on the object or in the nearby area (compositing effects, drop shadows, transparency, lenses, etc.) are applied as well. Moreover, the sample stylized object and its rasterized version for display need only exist for the relatively brief moment of time and does not need to be saved.

Using the same process, a style set can also be viewed by applying the style set to a sample object. The sample object, stylized by the style set selected for view, can be similarly displayed in an on screen window such as a tool tip window.

Certain aspects of properties, styles, and style sets are first described, before continuing with a more detailed description of the style view process.

Parent and Child Styles:

Styles or properties of styles can be defined differently in the child in comparison to the parent. In many cases, it can be advantageous to adopt many or most of a set of properties of a parent style, except one or more properties that should have a different state than the parent style.

FIG. 1 shows an exemplary structure of a style “Myfill”, a hypothetical style containing properties of a fill color of an object. The hypothetical properties of Myfill are color and type. FIG. 2 shows another aspect of styles referred to as inheritance. In FIG. 2, the style Myfill2 is created as a “child style” and takes on or “inherits” properties of a “parent” style Myfill. For example, in FIG. 2, the “child” style Myfill2 has inherited all of the states of the properties defined by Myfill, except for the property type, which in the case of Myfill2 is type 2 compared with type 1 of the parent style.

FIG. 3 shows a process diagram advancing with time which illustrates one exemplary process by which inheritance can operate. Hypothetical child style Fill has a color property, a type property, and an inheritance property. As the process advances in time, to apply the style Fill, the process considers if the style is a child style by examining the parent property. In the second step of FIG. 3, the Fill style is found to be a child of the style Myfill. Accordingly, the properties of color and type can be inherited from the parent style Myfill. However, in the last step, it can be seen that the creator of the style Fill chose not to inherit the color property from the parent style Myfill by defining the color blue. Therefore the style Fill has inherited all of the properties and states of its properties from the parent style Myfill, except for the state of the color property, which is blue for the child style Fill.

Style sets can have parent and child states in a similar way as styles. In the case of a style set, the child style set inherits all of the styles of the parent style set, except for any styles which are otherwise differently defined in the child style set.

There can be menus or other such user selections where a user can select which properties of a child state will have a different state from those of the parent style. Such user selections can take the form of a window or “docker” with selectable items representing each property of the parent or child style. There can be, for example, boxes that can be checked to indicate if a particular property should inherit its state from the parent style. Moreover, there can be a graphical indication associated with each property selection for a quick visual identification of which properties of the child style are inherited from the parent style. For example, a green indicator can show a property that has inherited the state of the parent style, while an orange indication near the same property box can indicate a property where the child has overridden the inherited state to substitute a different state for that same property in the child style.

FIG. 4A shows one exemplary docker 401 with a tooltip view 402. FIG. 4B shows the context of a style being applied to an object 411a with tooltip view 402. FIG. 4C shows the resulting object 411b after the style has been applied.

Now turning back to a more detailed description of the process of style view, a style view can be used to view either a parent style or a child style. It is unimportant to the view process if one or more of the properties of the parent style are overridden by a child style. Similarly, the view process can be used to view a parent style set or a child style set.

The first step in the view process is to determine by computer an object suitable to view a selected style, then to generate the sample object by computer. A sample object is generally selected based on its ability to show the visually recognizable aspects of the style set selected for view. The sample object can be native to the type of computer program in use. For example, for a vector based computer drawing program, the generated sample object can be a vector sample object.

It can now be seen that the style view process as described hereinabove is distinguished from a process that might actually apply a style to one or more objects of a computer drawing and render the actual drawing as so modified by the selected style. One of the main differences being that according to the view process, the style being viewed is applied to a generic sample object chosen by the computer program and applied to the sample object for view and not to the actual computer drawing. Moreover, a stylized version of the sample object is then viewed on the screen, a dramatically less computational and graphic display load on the computer than the alternative of viewing the new style as applied to an actual redrawn computer drawing.

Example: A QR code is a 2D barcode, a type of barcode. A QR code is in a computer drawing. To view different QR code styles, a user selects a QR code style for view. A sample QR code object is generated. Because the style view process is substantially independent of any data or information code in the barcode, to further save view time, the sample QR code object is generally not encoded or decoded as part of the view process. A style including a QR fill color blue is selected and that style is applied to the sample QR code object. The QR code object is rendered as a rasterized object in pixel form (a bit mapped image) which is then shown inside of a tool tip window.

Example: Computer drawings can also include text. Text can have a variety of properties which can be grouped in a style. In such text (e.g. any alphanumeric characters) view, the computer can select an alphanumeric object best suited to show the visual attributes of a text style, as for example, can include font type, font color, and any other suitable font attributes such as bold, sharp, outlined, beveled edges, etc.).

Text properties and styles can also include character and formatting information. Two exemplary text styles are character styles and paragraph styles. A paragraph style can include paragraph formatting information.

FIG. 5 shows a block diagram of an exemplary method for efficiently viewing a style. The steps include: A) Provide a computer readable non-transitory storage medium including a computer readable code configured to run on a computer and to perform a process to view an assignment of a style to an object of a computer drawing; B) Select the style for view; C) Choose by computer a sample object, the sample object configured to visually demonstrate one or more visual properties of the style; D) Apply by computer the style to the sample object; E) Render by computer the sample object to a bit mapped image suitable for display on a computer display; and F) Displaying by computer the pixelated image on the computer display.

FIG. 6 shows block diagram of an exemplary method to assign a child style inherited from a parent style to an object of a computer drawing. The steps include: A) Provide a computer readable non-transitory storage medium including a computer readable code configured to run on a computer and to perform a process to assign a child style to an object, the child style including one or more properties inherited from a parent style; B) Select a parent style; C) Create a child style to inherit the one or more properties from the parent style; D) Assign the created child style to an object; and E) Apply by computer the created child style to the object of the computer drawing.

It will be understood by those skilled in the art that a preliminary process step can include providing a computer readable non-transitory storage medium comprising computer readable code configured to run on a computer and to perform a process to view an assignment of a style to an object of a computer drawing.

A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, etc.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer readable non-transitory storage medium comprising a computer readable code configured to run on a computer and to perform a process to view an assignment of a style to an object of a computer drawing;
selecting said style to view;
choosing by computer a sample object, said sample object configured to visually demonstrate one or more visual properties of said style;
applying by computer said style to said sample object;
rendering by computer said sample object to a bit mapped image suitable for display on a computer display; and
displaying by computer said pixelated image on said computer display.

2. The method of claim 1, wherein said step of selecting said style to view comprises selecting a style from the group consisting of a style to preview, a style to create, and a style to edit.

3. The method of claim 1, wherein said step of choosing by computer a sample object comprises choosing a sample object selected from a group of generic objects.

4. The method of claim 1, wherein said step of rendering by computer said sample object to a bit mapped image suitable for display on a computer display comprises displaying said bit mapped image in a window.

5. The method of claim 1, wherein said step of rendering by computer said sample object to a bit mapped image suitable for display on a computer display comprises displaying said bit mapped image in a tool tip window.

6. The method of claim 1 wherein an underlying computer file of said computer drawing remains unmodified by said process to view an assignment of said style to an object of a computer drawing.

7. The method of claim 1, wherein said style is a parent style or a child style.

8. The method of claim 1, wherein said object comprises a shape.

9. The method of claim 1, wherein said object comprises one or more characters of text.

10. The method of claim 1, wherein said object comprises one or more paragraphs of text.

11. The method of claim 1, wherein said object comprises a barcode object and said process to view an assignment of a style to an object of a computer drawing operates without information of any data stored within said barcode.

12. The method of claim 11, wherein said barcode object comprises a QR code.

13. A system comprising:
A computer configured to run a computer readable non-transitory storage medium comprising a computer readable code configured to run on said computer and to perform a process to view an assignment of a style to an object of a computer drawing;
a user input device communicatively coupled to said computer; and
wherein said computer readable code is configured to recognize a selection of said style for view made with said user input device and to choose a sample object, wherein said sample object is configured to visually demonstrate one or more visual properties of said style, and to apply by computer said style to said sample object, and to render by computer said sample object to a bit mapped image suitable for display on a computer display, and to display by computer said pixelated image on said computer display.

14. A method comprising the steps of:
providing a computer readable non-transitory storage medium comprising a computer readable code configured to run on a computer and to perform a process to assign a child style to an object, said child style comprising one or more properties inherited from a parent style;
selecting a parent style;
creating a child style to inherit said one or more properties from said parent style;
assigning said created child style to an object; and
applying by computer said created child style to said object of said computer drawing.

15. The method of claim 14, further including the step of providing a process to view an assignment of a style to an object of a computer drawing according to claim 1, and between said step of creating a child style and said step of assigning said created child style to an object, the step of viewing said child style.

16. A method comprising the steps of:
providing a computer readable non-transitory storage medium comprising a computer readable code configured to run on a computer and to perform a process to view an assignment of a style set to an object of a computer drawing;
selecting said style set for view;
choosing by computer a sample object, said sample object configured to visually demonstrate one or more visual properties of said style set;
applying by computer said style set to said sample object;
rendering by computer said sample object to a bit mapped image suitable for display on a computer display; and
displaying by computer said pixelated image on said computer display.

17. The method of claim 16, wherein said step of selecting said style set to view comprises selecting a style set from the group consisting of a style set to preview, a style set to create, and a style set to edit.

18. The method of claim 16, wherein said style set is a parent style set or a child style set.

19. The method of claim 16, wherein said step of choosing by computer a sample object comprises choosing a sample object selected from a group of generic objects.

20. The method of claim 16, wherein said step of rendering by computer said sample object to a bit mapped image suitable for display on a computer display comprises displaying said bit mapped image in a window.

21. The method of claim 16, wherein said step of rendering by computer said sample object to a bit mapped image suitable for display on a computer display comprises displaying said bit mapped image in a tool tip window.

22. The method of claim 16, wherein an underlying computer file of said computer drawing remains unmodified by said process to view an assignment of said style set to an object of a computer drawing.

23. The method of claim 16, wherein said style set is a parent style set or a child style set.

24. The method of claim 16, wherein said object comprises a shape.

25. The method of claim 16, wherein said object comprises one or more characters of text.

26. The method of claim 16, wherein said object comprises one or more paragraphs of text.

27. The method of claim 16, wherein said object comprises a barcode object and said process to view an assignment of a style set to an object of a computer drawing operates without information of any data stored within said barcode.

28. The method of claim 27, wherein said barcode object comprises a QR code.
